(19) United States
(12) Patent Application Publication
(10) Pub. No.: US 2018/0184477 A1
(43) Pub. Date: Jun. 28, 2018

(54) METHOD, APP AND SYSTEM FOR SIMULTANEOUS FUNCTION OF WIFI ANTENNA AND CELLULAR DATA ANTENNA

(71) Applicant: Voxx International Corporation, Hauppauge, NY (US)

(72) Inventors: Jose Paredes, Orlando, FL (US); Joseph C. Caltabiano, Hauppauge, NY (US)

(21) Appl. No.: 15/855,231

(22) Filed: Dec. 27, 2017

Related U.S. Application Data
(60) Provisional application No. 62/439,624, filed on Dec. 28, 2016.

(51) Int. Cl. H04W 76/15; H04W 84/12; H04L 29/12; H04W 84/04

(52) U.S. Cl. CPC H04W 76/15; H04W 84/12; H04W 84/042; H04L 61/6095; H04L 61/2007

(57) ABSTRACT

A method for configuring a device's cellular data antenna and WiFi antenna to function simultaneously, the method including: in a mobile app, opening the device's WiFi settings and selecting a WiFi network to connect the device to; after connecting the device to the WiFi network, selecting to use cellular network data; adjusting the device's settings to keep the cellular data antenna and WiFi antenna connected at the same time; and selecting media content to be streamed wirelessly to the device via the cellular data antenna while the WiFi antenna is connected.

### CROSS-REFERENCE TO RELATED APPLICATION

This application claims priority under 35 U.S.C. § 119/120 to U.S. provisional application No. 62/439,624, filed on Dec. 28, 2016 in the U.S. Patent and Trademark Office, the disclosure of which is incorporated by reference herein in its entirety.

### TECHNICAL FIELD

The present invention relates to mobile devices, and more particularly, to smartphones and tablets.

### SUMMARY

According to an exemplary embodiment of the present invention, there is provided a method for configuring a device's cellular data antenna and WiFi antenna to function simultaneously, the method comprising: in a mobile app, opening the device's WiFi settings and selecting a WiFi network to connect the device to; after connecting the device to the WiFi network, selecting to use cellular network data; adjusting the device's settings to keep the cellular data antenna and WiFi antenna connected at the same time; and selecting media content to be streamed wirelessly to the device via the cellular data antenna while the WiFi antenna is connected.

According to an exemplary embodiment of the present invention, the method further comprises streaming the media content to another device via using the WiFi antenna.

According to an exemplary embodiment of the present invention, a first portion of the media content is streamed to the another device via the WiFi antenna while a second portion of the media content is streamed to the device via the cellular data antenna.

According to an exemplary embodiment of the present invention, the device is a smartphone or a tablet.

According to an exemplary embodiment of the present invention, adjusting the device's settings to keep the cellular data antenna and WiFi antenna connected at the same time comprises: clicking on a static internet protocol (ip) address; copying the ip address and a subnet mask; pasting the ip address and the subnet mask; and leaving router, domain name system (dns) and search domains blank.

According to an exemplary embodiment of the present invention, the device has an iOS operating system.

According to an exemplary embodiment of the present invention, only the ip address and subnet mask are copied.

According to an exemplary embodiment of the present invention, adjusting the device's settings to keep the cellular data antenna and WiFi antenna connected at the same time comprises: modifying an ip address; choosing a static ip address; copying the ip address and a subnet mask; pasting the ip address and the subnet mask; and leaving router, dns and search domains blank.

According to an exemplary embodiment of the present invention, the device has an android operating system.

According to an exemplary embodiment of the present invention, only the ip address and subnet mask are copied.

According to an exemplary embodiment of the present invention, there is provided a method for configuring a device's cellular data antenna and WiFi antenna to function simultaneously, the method comprising: in a software app, opening the device's WiFi settings and selecting a WiFi network to connect the device to; after connecting the device to the WiFi network, selecting to use cellular network data; adjusting the device's settings to keep the cellular data antenna and WiFi antenna connected at the same time; and selecting media content to be streamed wirelessly to the device via the cellular data antenna while the WiFi antenna is connected, wherein adjusting the device's settings to keep the cellular data antenna and WiFi antenna connected at the same time comprises: clicking on a static internet protocol (ip) address; copying the ip address and a subnet mask; pasting the ip address and the subnet mask; and leaving router, domain name system (dns) and search domains blank.

According to an exemplary embodiment of the present invention, the device has an iOS operating system.

According to an exemplary embodiment of the present invention, only the ip address and subnet mask are copied.

According to an exemplary embodiment of the present invention, there is provided a method for configuring a device's cellular data antenna and WiFi antenna to function simultaneously, the method comprising: in a mobile app, opening the device's WiFi settings and selecting a WiFi network to connect the device to; after connecting the device to the WiFi network, selecting to use cellular network data; adjusting the device's settings to keep the cellular data antenna and WiFi antenna connected at the same time; and selecting media content to be streamed wirelessly to the device via the cellular data antenna while the WiFi antenna is connected, wherein adjusting the device's settings to keep the cellular data antenna and WiFi antenna connected at the same time comprises: modifying an ip address; choosing a static ip address; copying the ip address and a subnet mask; pasting the ip address and the subnet mask; and leaving router, dns and search domains blank.

According to an exemplary embodiment of the present invention, the device has an android operating system.

According to an exemplary embodiment of the present invention, only the ip address and subnet mask are copied.

### BRIEF DESCRIPTION OF THE DRAWINGS

FIG. 1 illustrates a system according to an exemplary embodiment of the present invention;

FIG. 2 illustrates a method according to an exemplary embodiment of the present invention;

FIG. 3 illustrates a method according to an exemplary embodiment of the present invention; and

FIG. 4 illustrates a method according to an exemplary embodiment of the present invention

### DETAILED DESCRIPTION OF EXEMPLARY EMBODIMENTS

An exemplary embodiment of the present invention will be first discussed with reference to an example use case. In this use case, the present invention is applied to the field of automotive rear seat entertainment.

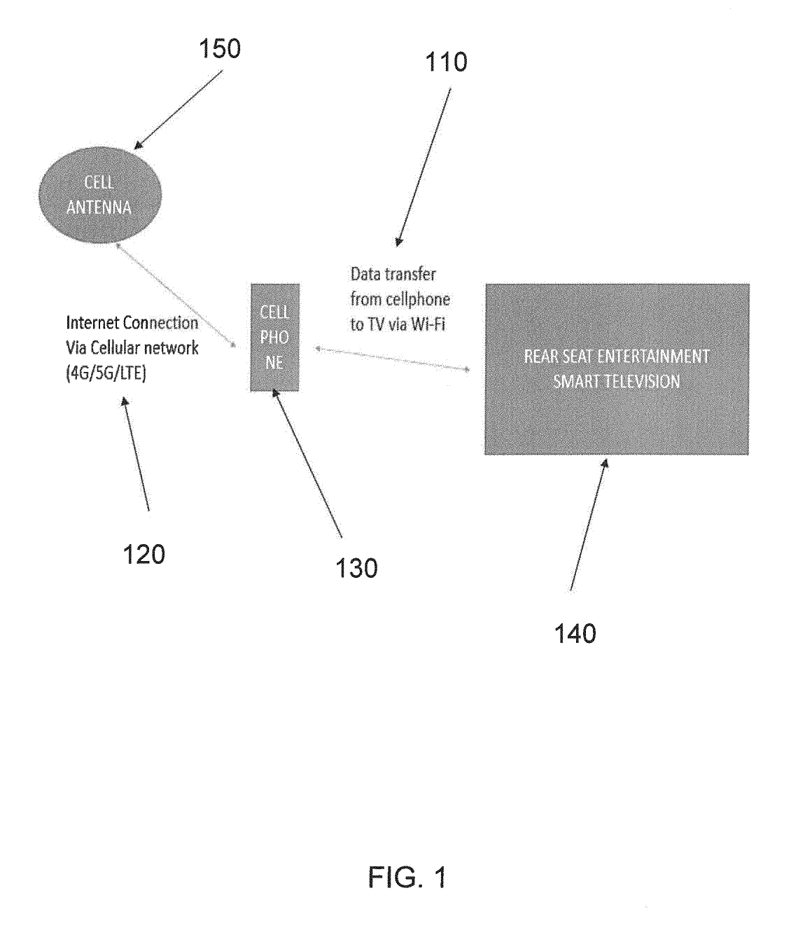

In reference to FIG. 1, the present invention provides an application (hereinafter interchangeably referred to as an “app”) on a user's Smartphone/Tablet that will keep both the Smartphone's/Tablet's Wi-Fi connectivity 110 and the data cellular antenna 120 functioning at the same time. In general, when a Smartphone/Tablet joins a Wi-Fi network, the data exchange (e.g., 3G/4G/LTE) between the Smartphone and the carrier (Verizon/ATT/T-Mobile etc.) shuts off. The purpose of this app is to keep both the cellular Data and Wi-Fi networks on and connected.

When a Smartphone/Tablet is connected via a Wi-Fi peer-to-peer connection to a rear seat entertainment system network, activating the Wi-Fi connection will shut off the data exchange from cellular networks as described above. However, in accordance with an exemplary embodiment of the present invention, the user will open the inventive application on their Smartphone/Tablet 130. This application will then manipulate the Smartphone's/Tablet's settings to turn on the cellular data network on the Smartphone/Tablet. This will allow the Smartphone/Tablet to be connected to a rear seat entertainment system's 140 (110) non-internet Wi-Fi network while also being connected to the internet via the Smartphone's/Tablet's Cellular Data network 150 (120).

This will allow a user to wirelessly stream content into their Smartphone/Tablet from the internet/cloud and, at the same time, send the content wirelessly to a rear seat entertainment system. Thereby, using the Smartphone/Tablet as a conduit for cloud based content such as: Netflix, Hulu, YouTube, HBO-go etc.

An exemplary embodiment of the present invention will be discussed with reference to another example use case. In this use case, the present invention is used in an automobile. Although similar to use case 1, what is different here is that the app will connect a Smart TV via UPNP/DLNA.

In this case, the app can perform the following functions:

1. Connect both the Smartphone's/Tablet's Wi-Fi and Cellular Data connections at the same time.

2. Give the user the ability to either watch media on their Smartphone/Tablet or to wirelessly send that content to a Smart TV.

3. Save media streaming in from a cellular network for approximately 5-10 seconds while it is translated into UPNP/DLNA protocol, then stream it wirelessly via Wi-Fi to Smart TV.

In these use cases above, the Smartphone/Tablet will not have a Wi-Fi internet connection. The Smartphone/Tablet will have the internet connection via cellular data from the user's carrier.

A method according to an exemplary embodiment of the present invention may be implemented with a mobile app. A mobile app is a computer program designed to run on a mobile device such as a phone/tablet or watch. The app may be downloaded from an app store such as Google Play or Apple's App Store, for example.

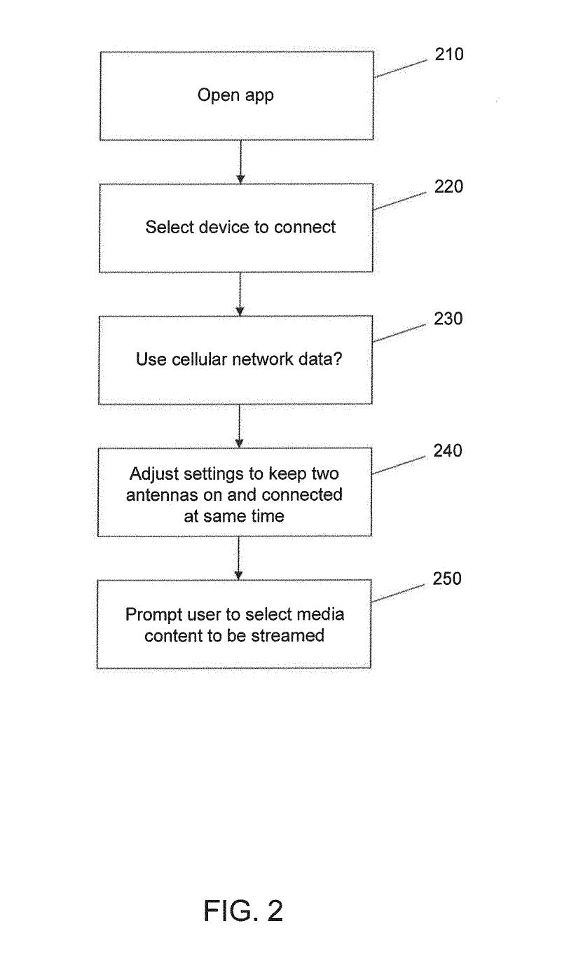

Referring now to FIG. 2, a method according to an exemplary embodiment of the present invention is as follows:

1. Open the application according to an exemplary embodiment of the present invention on a user's Smartphone/Tablet (210).

2. The application according to an exemplary embodiment of the present invention will open up the Smartphone's/Tablet's Wi-Fi settings and prompt—Select a device to connect (220).

3. After connected to the desired Wi-Fi network, the application according to an exemplary embodiment of the present invention will ask again—Use cellular network data (live content) (230)?

4. If “yes” is selected, at this point the application according to an exemplary embodiment of the present invention may alert the user “additional data costs may occur”.

5. If “yes” is chosen, the application according to an exemplary embodiment of the present invention will manipulate the Smartphone's/Tablet's settings to keep two antennas (Wi-Fi and Cellular Data) on and connected at the same time (240).

6. The application according to an exemplary embodiment of the present invention will then prompt the user to follow instructions such as (250):
a. Select app for media content: Netfllix, HBO, Hulu . . . etc.
b. When media content is selected, a pop up window will prompt the user to stream the content wirelessly to the device selected in step number 2.

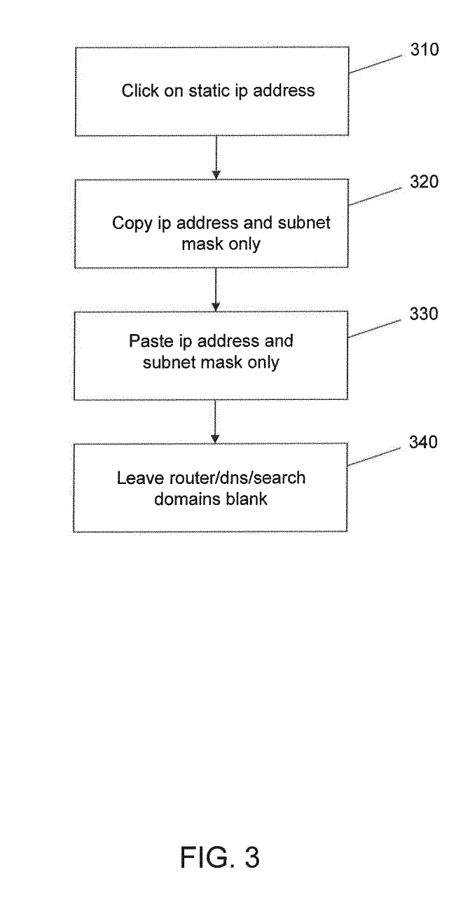

Referring now to FIG. 3, a method for adjusting the device's settings to keep the cellular data antenna and Wi-Fi antenna connected at the same time according to an exemplary embodiment of the present invention is described below.

In particular, when operating an Iphone, the following steps may be performed automatically by the app to keep both the WiFi and Cellular data antennas on at the same time. These steps may also be performed manually.

1. Enter Settings on phone.

2. Goto Wi-Fi.

3. Choose Wi-Fi network.

4. Click on a static internet protocol (ip) address (310).

5. Copy/paste ip address and subnet mask only (320/330).

6. Leave router/dns/search domains blank (340).

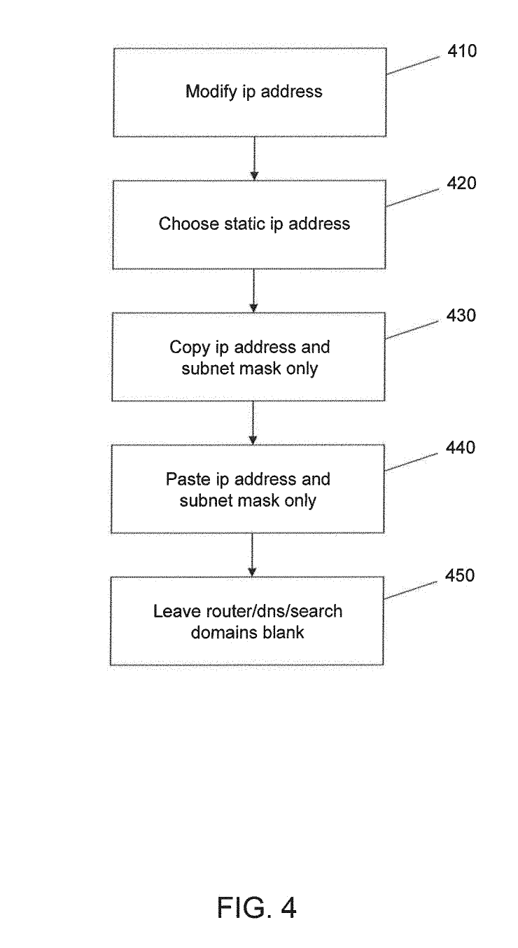

Referring now to FIG. 4, a method for adjusting the device's settings to keep the cellular data antenna and Wi-Fi antenna connected at the same time according to an exemplary embodiment of the present invention is described below.

In particular, when operating an Android phone, the following steps may be performed automatically by the app to keep both the WiFi and Cellular data antennas on at the same time. These steps may also be performed manually.

1. Enter Settings on phone.

2. Goto Wi-Fi.

3. Modify ip address (410).

4. Choose static ip address (420).

5. Copy/paste ip address and subnet mask only (430/440).

6. Leave router/dns/search domains blank (450).

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

What is claimed is:

1. A method for configuring a device's cellular data antenna and WiFi antenna to function simultaneously, the method comprising:
in a mobile app, opening the device's WiFi settings and selecting a WiFi network to connect the device to;
after connecting the device to the WiFi network, selecting to use cellular network data;
adjusting the device's settings to keep the cellular data antenna and WiFi antenna connected at the same time; and
selecting media content to be streamed wirelessly to the device via the cellular data antenna while the WiFi antenna is connected.

2. The method of claim 1, further comprising streaming the media content to another device via using the WiFi antenna.

3. The method of claim 2, wherein a first portion of the media content is streamed to the another device via the WiFi antenna while a second portion of the media content is streamed to the device via the cellular data antenna.

4. The method of claim 1, wherein the device is a smartphone or a tablet.

5. The method of claim 1, wherein adjusting the device's settings to keep the cellular data antenna and WiFi antenna connected at the same time comprises:
selecting a static internet protocol (ip) address;
copying the ip address and a subnet mask;
pasting the ip address and the subnet mask; and
leaving router, domain name system (dns) and search domains blank.

6. The method of claim 5, wherein the device has an iOS operating system.

7. The method of claim 5, wherein only the ip address and subnet mask are copied.

8. The method of claim 1, wherein adjusting the device's settings to keep the cellular data antenna and WiFi antenna connected at the same time comprises:
modifying an internet protocol (ip) address;
choosing a static ip address;
copying the ip address and a subnet mask;
pasting the ip address and the subnet mask; and
leaving router, domain name system (dns) and search domains blank.

9. The method of claim 8, wherein the device has an android operating system.

10. The method of claim 8, wherein only the ip address and subnet mask are copied.

11. A method for configuring a device's cellular data antenna and WiFi antenna to function simultaneously, the method comprising:
in a software app, opening the device's WiFi settings and selecting a WiFi network to connect the device to;
after connecting the device to the WiFi network, selecting to use cellular network data;
adjusting the device's settings to keep the cellular data antenna and WiFi antenna connected at the same time; and
selecting media content to be streamed wirelessly to the device via the cellular data antenna while the WiFi antenna is connected,
wherein adjusting the device's settings to keep the cellular data antenna and WiFi antenna connected at the same time comprises:
clicking on a static internet protocol (ip) address;
copying the ip address and a subnet mask;
pasting the ip address and the subnet mask; and
leaving router, domain name system (dns) and search domains blank.

12. The method of claim 11, wherein the device has an iOS operating system.

13. The method of claim 11, wherein only the ip address and subnet mask are copied.

14. A method for configuring a device's cellular data antenna and WiFi antenna to function simultaneously, the method comprising:
in a mobile app, opening the device's WiFi settings and selecting a WiFi network to connect the device to;
after connecting the device to the WiFi network, selecting to use cellular network data;
adjusting the device's settings to keep the cellular data antenna and WiFi antenna connected at the same time; and
selecting media content to be streamed wirelessly to the device via the cellular data antenna while the WiFi antenna is connected,
wherein adjusting the device's settings to keep the cellular data antenna and WiFi antenna connected at the same time comprises:
modifying an internet protocol (ip) address;
choosing a static ip address;
copying the ip address and a subnet mask;
pasting the ip address and the subnet mask; and
leaving router, domain name system (dns) and search domains blank.

15. The method of claim 14, wherein the device has an android operating system.

16. The method of claim 14, wherein only the ip address and subnet mask are copied.
